(19) United States
(12) Patent Application Publication
(10) Pub. No.: US 2007/0142201 A1
(43) Pub. Date: Jun. 21, 2007

(54) Multi-component glass

(75) Inventors: Monika Oswald, Hanau (DE); Klaus Deller, Hainburg (DE); Rolf Clasen, St. Ingbert (DE)

Correspondence Address: VENABLE LLP, P.O. BOX 34385, WASHINGTON, DC, 20043-9998, US

(73) Assignee: DeGussa AG, Dusseldorf (DE)

(21) Appl. No.: 10/555,184

(22) PCT Filed: Apr. 17, 2004
(86) PCT No.: PCT/EP04/04096

§ 371 Date: Aug. 25, 2006

(30) Foreign Application Priority Data
May 2, 2003 (DE) 10319596.3

(51) Int. Cl. C03C 3/00; C03C 3/076; C03B 8/00

(52) U.S. Cl. 501/12; 501/55; 65/17.2

(57) ABSTRACT

A multi-component glass which, in addition to the components TiO₂ and SiO₂, comprises a further component from the group consisting of glass-forming agents and/or intermediate oxides is prepared by preparing mixtures of the starting components and reacting these to give the desired compositions, or treating a green body with a suspension of the additional components and reacting it to give the desired composition. The multi-component glass can be used for the production of shaped bodies with dimensions close to the final dimensions.

The invention relates to a multi-component glass, a process for its preparation and its use.

Two groups of materials which have a low or even negative thermal expansion coefficient are known. These materials are employed for uses where the highest geometric precision is required including during variations in temperature, such as, for example, large lightweight reflecting telescopes (J. Spangenberg-Jolly, Zero Expansion Glass for Telescope Mirror Blanks. Ceram. Bull. 69 (1990) 1922-1924,
S. T. Gulati and M. J. Edwards. ULE-zero expansion, low density, and dimensionally stable material for lightweight optical systems. Advanced materials for optics and precision structures, Vol. 67 (1997), SPIE: Bellingham, USA 107-136,
C. L. Davis and M. W. Linder, Low cost light weight mirror blank, U.S. Pat. No. 6,176,588 Patent, Corning Inc., Corning, N.Y. (USA), 2001,)
   Components for Nanolithography
(K. Hrdina, Production and properties of ULE glass with regards to EUV masks. Int. Workshop Extreme UV Lithography, (1999), Monterey, Calif., USA,
C. L. Davis, K. E. Hrdina and R. Sabis, Extreme ultraviolet soft X-ray projection lithographic method and mask devices, Int. Publ. Number WO 01/07967 A1, Patent, Corning Inc., Corning, N.Y. (USA), 2001,
C. L. Davis and K. E. Hrdina, Extreme ultraviolet soft X-ray projection lithographic method system and lithography elements, Int. Publ. Number WO 01/08163 A1, Patent, Corning Inc., Corning, N.Y. (USA), 2001,)
   or reflection optics for X-ray beams, or where, during wide variations in temperature, critical tensile stresses in the component due to locally different thermal expansions must be avoided.

Glass ceramic systems form the first group.

Components of glass ceramics are produced by shaping from the glass melt. The composition of the glass melt is such that during subsequent tempering of the shaped body a controlled crystallization occurs above the transformation temperature of the glass. Crystalline phases with a negative thermal expansion coefficient, which compensate the positive thermal expansion coefficient of the remaining glass matrix, are formed during this. Known examples are glass ceramics from Schott Glas in Mainz, which are marketed under the name Ceran® or Zerodur® and have been employed for years for hot-plates and telescope mirrors.

Li—Al silicate ceramics, which have a similar composition to the glass ceramics and also have a negative thermal expansion coefficient, can also be prepared from powders via a sintering process (S. L. Swartz, Ceramics having negative coefficient of thermal expansion, method of making such ceramics, and parts made from such ceramics, U.S. Pat. No. 6,066,585, Patent, Emerson Electric Co., 2000).

Two-component glasses form the second group (zero expansion glasses, ZEG).

The ULE® glasses from Corning (USA), which, in addition to SiO₂, comprise approx. 7 wt. % TiO₂, have already been known for a long time
(M. E. Nordberg, Glass having an expansion lower than that of silica, U.S. Pat. No. 2,326,059, Patent, Corning Glass Works, New York, 1939,
G. J. Copley, A. D. Redmond and B. Yates, The influence of titania upon the thermal expansion of vitreous silica. Phys. Chem. Glasses 14 (1973) 73-76,
P. C. Schultz, Binary Titania-Silica Glasses Containing 10 to 20 wt.-% TiO₂. J. Am. Ceram. Soc. 59 (1976) 214-219)

At higher TiO₂ contents the thermal expansion coefficient of these (single-phase) glasses even becomes negative, the risk of crystallization increasing significantly with an increasing TiO₂ content.

It is furthermore known that by fluorine doping of silica glass the expansion coefficient can be lowered from 0.5×10⁻⁶/K to 0.1×10⁻⁶/K
(P. K. Bachmann, D. U. Wiechert and T. P. M. Meeuwsen, Thermal expansion coefficients of doped and undoped silica prepared by means of PCVD. J. Mater. Sci. 23 (1988) 2584-2588).

Another example is the significant reduction in the expansion coefficient of a borate glass by addition of CeO₂
(G. El-Damrawi and K. El-Egili, Characterization of novel CeO₂—B₂O₃ glasses, structure and properties, Physica B 299 (2001) 180-186).

Only few multi-component glasses based on TiO₂ and SiO₂ are known, such as, for example, K₂O—SiO₂—TiO₂ glass
(B. V. J. Rao, The dual role of titanium on the system K₂O—SiO₂—TiO₂. Phys. Chem. Glasses 4 (1963) 22-34,
N. Iwamoto and Y. Tsunawaki, Raman spectra of K₂O—SiO₂—TiO₂-glasses. J. Non-Cryst. Solids 18 (1975) 303-306 or Al₂O₃—SiO₂—TiO₂ glass
P. C. Schultz and W. H. Dumbaugh, Silica-rich glasses in the TiO₂—Al₂O₃ system. J. Non-Cryst. Solids 38-39 (1980) 33-37).

The thermal expansion coefficient increases significantly in both compositions.

The ZEG glasses have the disadvantage, compared with glass ceramic, that the passing of the thermal expansion through zero cannot be adjusted by the composition. In the case of the Corning ULE glasses, which are prepared via gas phase deposition
(J. L. Blackwell, D. Dasler, A. R. Sutton and C. M. Truesdale, Method of making titania-doped fused silica, WO 98/39496, Patent, Corning Incorporated, 1998),
   variations in homogeneity in large shaped bodies furthermore can be prevented only with difficulty.

It was not possible to reduce variations in refractive index of 4×10⁻⁵ by sol-gel processes
(R. D. Shoup, Ultra-Low Expansion Glass from Gels. J. Sol-Gel Sci. Technol. 2 (1994) 861-864).

It is furthermore to be noted that thermal pretreatment has a significant influence on the properties of ULE glasses
P. P. Bihuniak and R. A. Condrate, Effects of preparation history on TiO₂—SiO₂ glasses. J. Am. Ceram. Soc. 64 (1981) C110-C112).

The invention provides a multi-component glass, which is characterized in that, in addition to the components TiO₂ and SiO₂, it comprises a further component from the group consisting of glass-forming agents and/or intermediate oxides.

Glass-forming agents can be oxides such as, for example, B₂O₃. Intermediate oxides can be oxides such as, for example, CeO₂.

The problems of the prior art mentioned are solved according to the invention in that at least one further network-forming glass component which at most slightly increases and primarily even further decreases the thermal expansion is added to the TiO₂—SiO₂ glass. The third or all further components furthermore have the effect that the stability of the TiO₂ in the silicate glass matrix is improved, without substantially influencing the chemical properties.

This third component can be:
glass-forming agents, for example B₂O₃
intermediate oxides, for example CeO₂

Network-forming polyvalent cations, such as B₂O₃, have proved to be particularly advantageous, it being possible for the glass to comprise 70-90 wt. % SiO₂, 1-10 wt. % TiO₂ and 0.1-7 wt. % B₂O₃.

The components furthermore can be distributed so homogeneously that no nucleation takes place and crystallization of individual components is therefore suppressed.

There are two process for preparation of the glass composition according to the invention:
a) Mixtures of the starting components are prepared, these mixtures being powder mixtures of the individual oxides or powder mixtures of mixed oxides and further components which are dispersed in a liquid, or mixtures of precursors which react to give the desired compositions (for example by the sol-gel process).
b) A green body which comprises at least one main component is treated with the additional components via an impregnation process with liquids, such as solutions or suspensions, which comprise the further additional components in the desired composition.

The solutions can be, for example, aqueous salt solutions or reactive alkoxide solutions in an alcohol, preferably ethanol. The latter can react, after introduction into the pores, and form oxide powder particles of the desired composition of the additional components homogeneously distributed in the pores in respect of the chemical composition.

The suspension can comprise very fine particles with diameters which are smaller than the average pore size of the green bodies to be impregnated.

It has proved advantageous to distribute the dispersed particles homogeneously in the open pore volumes of the green bodies by application of electrical fields (electrophoretic impregnation, EPI).

For this, the green body must have been filled beforehand with a low-conducting liquid, so that the dispersed particles of the suspension can move from a storage reservoir into the green body.

In both process variants shaped bodies with a geometry close to the final dimensions are produced, for example by pouring into a mould.

The dispersing liquid or the liquid phase formed during the reaction is then removed, after which the green body is formed.

The green body is then sintered to give a dense shaped body, the process temperature when nanopowders are used being significantly below the melting temperature of ULE glasses.

The considerable advantages of the multi-component glasses according to the invention are their improved glass stability and a lower sintering temperature.

Furthermore, by the shaping processes of powder technology shaped bodies with dimensions close to the final dimensions can be produced directly at room temperature, which avoids the high finishing costs of the glass ceramics and ULE glasses.

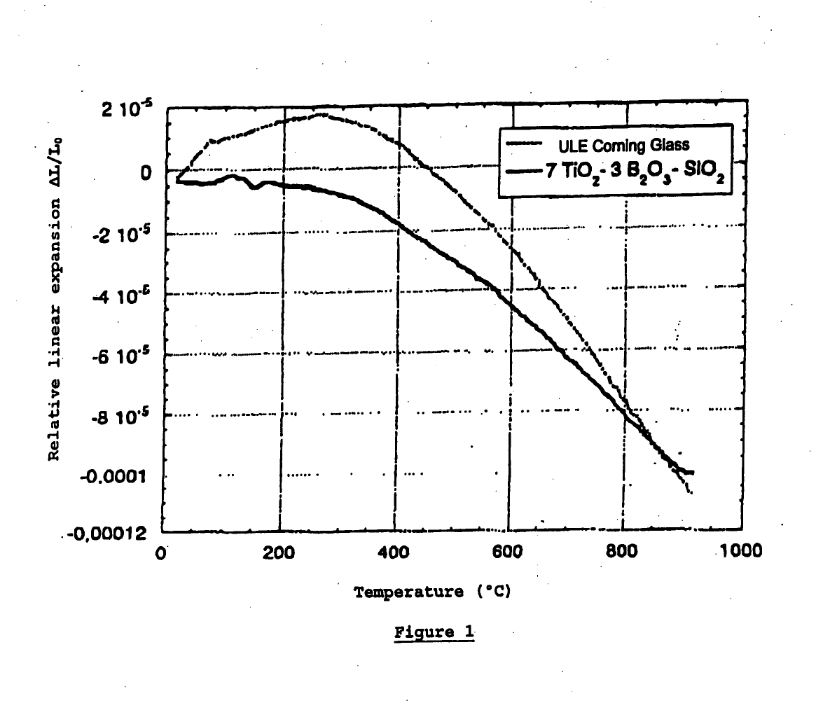

An example of the thermal expansion of a glass which has the composition according to the invention and is prepared via the sintering process (impregnation process) is shown in FIG. 1. It can be seen here that it was possible to achieve an improved course of the expansion compared with the Corning ULE glass by the addition of boron.

1. A multi-component glass comprising TiO₂, SiO₂ and one or more components selected from the group consisting of glass-forming agents and intermediate oxides.

2. A process for the preparation of the multi-component glass according to claim 1, comprising preparing mixtures of TiO₂, and SiO₂ which mixtures are powdered mixtures of the individual oxides or powdered mixtures of mixed oxides and dispersing the one or more glass forming and/or intermediate oxide components or precursors thereof in a liquid.

3. A process for the preparation of the multi-component glass according to claim 1, comprising impregnating a green body which comprises at least one main component with a liquid containing additional components, which comprise one or more of the glass forming and/or intermediate oxide components.

4. A process for the production of shaped bodies with dimensions close to those to the final desired dimensions comprising shaping the multi-component glass according to claim 1.

5. The process of claim 2 wherein the precursors react to form the glass forming and/or intermediate oxide components by a sol-gel process.

6. The process of claim 3 wherein the liquids are solutions or suspensions.
